(19) United States
(12) Patent Application Publication
(10) Pub. No.: US 2020/0040238 A1
(43) Pub. Date: Feb. 6, 2020

(54) CYANATE ESTER BASED ADHESIVE AND METHOD FOR PRODUCING CYANATE ESTER BASED ADHESIVE

(71) Applicant: NOLAX AG, Sempach Station (CH)

(72) Inventors: Markus LÄPPLE, Steinheim (DE); Erika ZIMMERMANN, Luzern (CH); Stephan BUSER, Sursee (CH); Alfredo MÜLLER, Zürich (CH)

(73) Assignee: nolax AG, Sempach Station (CH)

(21) Appl. No.: 16/339,098

(22) PCT Filed: Oct. 3, 2017
(86) PCT No.: PCT/EP2017/075051

§ 371 Date: Apr. 3, 2019

(30) Foreign Application Priority Data
Oct. 6, 2016 (EP) 16192527.6

(51) Int. Cl. C09J 175/00; C08G 18/02; C09J 5/02

(52) U.S. Cl. CPC C09J 175/00; C09J 2475/00; C09J 5/02; C08G 18/022

(57) ABSTRACT

A cyanate ester based adhesive comprising component A which has at least one cyanate ester with at least two OCN groups, and component B which comprises at least one catalyst for the trimerisation reaction of OCN groups to form a triazine ring. The catalyst is retained releasably on a carrier, particularly a pyrogenic silica.

The invention relates to a cyanate ester-based adhesive, to a method for producing a cyanate ester-based adhesive, and to the use of a cyanate ester-based adhesive for coating substrates.

For the lamination of high-temperature insulation materials such as, for example, a glass fiber mat/aluminum foil assembly, in the engine compartment or the exhaust systems of a vehicle, with both long-term and high-temperature (>300° C.) resistance properties, there are nowadays only a limited selection of adhesives on the market. Besides inorganic systems, mostly based on silicate, there are also polyimide-based and cyanate ester-based adhesive systems, and also silicone adhesives. Cyanate ester adhesives are nowadays usually produced by mixing in a catalyst, for the polymerization reaction of a cyanate ester, immediately prior to processing, then immediately applying the adhesive composition, and carrying out lamination and subsequent thermal crosslinking at 150 to 250° C., for example. The adhesive system composed of cyanate ester and catalyst is generally not storable at room temperature. Intermediate products precoated with cyanate ester must therefore be stored at very low temperatures, of −21° C., for example.

In principle, three cyanate groups of polyfunctional cyanate esters crosslink in the presence of a suitable catalyst, and through introduction of heat, to form a triazine ring; consequently, a cyanate ester-based adhesive cures to form a three-dimensional network.

Known from EP 1 265 947 B1 are quick-curing polymers composed of polycyanates and polycyanate/epoxide combinations with aminic hardeners as catalysts. The amine catalysts are present in encapsulated form in the adhesive composition, and are released, for example, by the melting of the capsules at elevated temperatures, with the commencement of the curing process. Disadvantages of this are the complicated provision of the catalyst in capsule form and also instances of local overheating during the polymerization reaction.

Known from WO 2012/139940 A1 are polyurethane compositions with complexed metal catalysts; during an induction phase, the catalytic reactivity is even lower, while after this induction period, high reactivity and catalytic effect are achieved in order to generate rapid crosslinking of the system to be crosslinked. The complexing is done using retardant substances. A disadvantage of this is that the polyurethane compositions described are limited to classes of catalyst that can be complexed.

Known from US 2013/131248 A1 is an organic-inorganic composite material composed of a triazine resin and a coating material. The triazine ring is synthesized from cyanate ester components. The coating material comprises a mixture of clay and a curing catalyst. The catalyst is likewise in the form of a complex and is incorporated as such into the clay.

Known from “Composites: Part A 39 (2008), pp. 761-768 (Goertzen W. K., Kessler, M. R.)” is a composition made up of a cyanate ester, a crosslinking catalyst, and pyrogenic silica. The crosslinking catalyst takes the form of a liquid phase.

A problem generally known to affect cyanate ester coatings is that the catalyst is present locally in excessive concentrations, possibly leading to an uncontrolled exothermic reaction profile. Furthermore, great cost and complexity is involved in the uniform incorporation of conventional catalysts.

It is an object of the invention to overcome the disadvantages of the prior art. Particular objects of the invention are to provide a storage-stable, cyanate ester-based adhesive and to provide a method for producing a storage-stable, cyanate ester-based adhesive. A further intention is to avoid local instances of excessive concentration of the catalyst. These objects are achieved with the independent claims 1 and 5.

The invention relates to a cyanate ester-based adhesive comprising a component A and a component B. Component A includes at least one cyanate ester having at least two OCN groups. Component B has at least one catalyst for the trimerization reaction of OCN groups to form a triazine ring. The catalyst here is retained reversibly on a carrier, particularly a pyrogenic silica. “Retained reversibly” here and hereinafter is understood to mean that the catalyst attaches to the surface of the carrier and/or is in contact with the surface of the carrier. This may be accomplished particularly by physical adsorption or chemical adsorption. In this way, the catalyst is distributed uniformly in the composition and any local excessive concentration when the catalyst is released is avoided. In this way the catalyst can be incorporated much more effectively. On the basis of the catalyst retained reversibly on the carrier, moreover, the storage stability of the composition is increased by a multiple.

Since, advantageously, the cyanate ester-based adhesive has latent reactivity, a substrate can be coated with a cyanate ester-based adhesive without the cyanate ester-based adhesive curing and/or experiencing a significant increase in its viscosity over the time. The coated substrate can be put into interim storage, before, in further operating steps, for example, the cyanate ester-based adhesive is cured and/or other components are arranged on the coated substrate. In the context of the polymerization reaction, which is highly exothermic, there are no adverse instances of local overheating due to heterogeneous local incorporation of the catalyst. Moreover, there is no need for any of the retardant substances, as known from the prior art, which, for example, complex the catalyst and so diminish the reactivity of the composition. In any case, the reaction which is observed to proceed is significantly more harmonious than with encapsulated or complexed catalysts. It has proven particularly advantageous that a cyanate ester-based adhesive of the invention exhibits stability of several days on hot storage at 60° C. and stability of >3 months at RT without any notable increase in the viscosity. With known cyanate ester-based compositions, an increase in the viscosity during storage at room temperature (around 20° C.) is recorded, owing to the commencement of the polymerization reaction, and this is a disadvantage.

The at least one catalyst may be present in the non-complexed state. Accordingly there is no need to incorporate a complexing component into the cyanate ester-based adhesive or to contact a catalyst beforehand with a complexing component.

The at least one catalyst may preferably be tin octoate. Tin octoate which is retained reversibly on a carrier, particularly pyrogenic silica, has emerged as being a preferred catalyst for the trimerization reaction of OCN groups to form a triazine ring and hence for the curing of the cyanate ester-based adhesive. Tin octoate is an especially suitable catalyst because, in comparison to Fe(III) and Co catalysts, it is inert at low temperatures and, furthermore, has the advantageous features of a low toxicity and high availability. It has been found, furthermore, that there is a much lower increase in the viscosity with tin octoate than with the customary catalysts such as Fe(III) acetylacetonate or Mn(II) acetylacetonate, for example.

Component B may include one or more catalysts for the trimerization reaction of OCN groups to form a triazine ring and hence for the curing of the cyanate ester-based adhesive. The catalyst or catalysts may account proportionally for 0.001 to 10 wt %, more preferably 0.01 to 5 wt %, very preferably 0.1 to 1 wt %, based on the cyanate ester. The aforesaid wt % are based on the overall composition.

The cyanate ester-based adhesive may comprise at least one filler in a proportion of at least 5 wt %, preferably at least 25 wt %, more preferably 30 wt %. Suitable fillers are inorganic fillers such as, for example, calcium carbonate (chalk), kaolin, montmorillonite (bentonite), wollastonite, pyrogenic silica, finely ground glass, finely ground recycled glass, hollow glass beads, pigments, glass fibers or basalt fibers, talc, or colorants. Other suitable fillers are organic fillers such as, for example, silicones, rubbers or known impact modifiers. A single filler or a plurality of fillers may be used. The filler content may be 25 to 30 wt %. There is no need for flame retardants to be added, since the fully reacted adhesive has extremely low flammability. In principle, however, there is no bar to the addition of flame retardants.

A further aspect of the invention relates to a method for producing a cyanate ester-based adhesive, particularly as elucidated above. The method comprises the step a) of contacting, particularly mixing, a component A and a component B in a solution. The component A here includes at least one cyanate ester having at least two OCN groups. Component B includes at least one catalyst, particularly tin octoate, for the trimerization reaction of OCN groups to form a triazine ring. The catalyst here is retained reversibly on a carrier, particularly a pyrogenic silica. The method optionally includes the step b) wherein the composition from a) is degassed under reduced pressure. In this way a method for producing a cyanate ester-based adhesive is provided that can be carried out simply and reproducibly. Furthermore, the method provides a cyanate ester-based adhesive which has the aforesaid advantages.

The contacting, particularly mixing, in step a) may take place at 20 to 100° C., preferably at 30 to 70° C., more preferably at not less than 60° C., for 1 to 10 min, preferably 2 to 8 min, more preferably 4 to 6 min. In this way the individual components of the composition are distributed particularly well and instances of local excessive concentration of individual components are ruled out.

Component A and/or component B may be provided as solution/s in step a) of the method. This means either that component A is introduced in solution and component B is incorporated as a solid into the solution of component A, or that component B is introduced in solution and component A is incorporated as a solid into the solution with component B. In this way there is a free choice as to whether one of the two components or both components are already present in solution. The user is therefore able to choose according to the situation.

Components A and B may be provided as solids in step a) and taken up in a solvent. Suitable solvents are known to the skilled person. Preferred solvents are aprotic solvents which have a boiling point of less than 200° C. The solvents, accordingly, can be removed advantageously during the curing step. A nonexhaustive list of suitable solvents embraces acetone, dichloromethane, tetrahydrofuran, diethylene glycol dimethyl or diethyl ether, diethylene glycol monobutyl ether acetate, ethyl methyl ketone, N-methylpyrrolidone, acetonitrile, dimethylformamide (DMF), dimethyl sulfoxide (DMSO), dimethyl carbonate, tetrahydrofuran (THF), dichloromethane, ethylene chloride, ethyl acetate. In this way, components A and B can be premixed as solids and taken up in a solvent, to the benefit of ease of handling.

To apply the catalyst, particularly the tin octoate, on the carrier, particularly the pyrogenic silica, the catalyst may be dissolved in a solvent, preferably acetone. The carrier, particularly the pyrogenic silica, may be added to the solvent that includes the catalyst and in this way contacted with the catalyst. The composition comprising catalyst and carrier may be mixed, particularly dispersed. Subsequently the solvent may be removed, particularly by evaporation. An optional possibility is for the with the catalyst retained reversibly thereon to be ground, following the removal of the solvent. This makes it particularly easy to apply the catalyst to a carrier, particularly a pyrogenic silica, so that the catalyst is retained reversibly on the carrier and can be provided in the method of the invention for producing a cyanate ester-based adhesive.

The invention relates further to the use of tin octoate as a catalyst for the trimerization reaction of OCN groups to form a triazine ring of a cyanate ester-based adhesive. In this case the tin octoate is retained reversibly on a carrier, particularly a pyrogenic silica. The advantages referred to above for tin octoate as a catalyst are of course equally valid for the use of tin octoate as a catalyst for the for the trimerization reaction of OCN groups to form a triazine ring of cyanate ester-based adhesive.

Another aspect of the invention is the use of a cyanate ester-based adhesive as elucidated above for coating a substrate. Here, the cyanate ester-based adhesive has the aforementioned characteristics and also the advantageous properties.

The invention relates further to a substrate having a coating with a cyanate ester-based adhesive as elucidated above. A substrate thus coated may be applied, particularly mounted, to a wide variety of different elements, especially components.

The invention further relates to the use of a substrate which is coated with a cyanate ester-based adhesive as is elucidated above for insulating a component in the area of automotive engineering/industry, housebuilding, shipbuilding, oven building, blast furnace construction, chemical reactors, aeronautical engineering/industry, aerospace, combined heat and power stations, cement kiln, refuse/waste incinerator. For this purpose, for example, the substrate is coated with a cyanate ester-based adhesive, a component is applied to the coating, and the coating is polymerized or cured by introduction of heat. This results in a component which includes an insulation system comprising the substrate.

A further aspect of the invention relates to a method for coating a component with a cyanate ester-based adhesive as elucidated above. The method comprises the steps of a) applying a cyanate ester-based adhesive to a substrate, b) applying the component to the cyanate ester-based adhesive applied to the substrate, and c) crosslinking the cyanate ester-based adhesive at a temperature of >100° C., preferably 220° C., for 1 to 30 min, preferably 5 to 10 min. Components are produced accordingly with a coating, especially a heat insulation system for high temperatures, with particular simplicity.

The crosslinking or polymerizing of the cyanate ester-based adhesive may take place in exclusion of atmospheric moisture. This may be done, for example, in a MEYER belt press. An advantage of the belt press is that it allows a controlled temperature regime. Furthermore, substrates, especially material in sheet form, can be efficiently precoated over the entire width with the latent-reactive cyanate ester-based adhesive. The precoated substrate, without being cooled, can be stored, transported and/or trimmed. Not until the ultimate curing can the reaction be triggered by an increase in the temperature.

The substrate and/or the component may be pretreated. Possible pretreatments in this context include, in particular, deactivation of the surface by means of chemical and/or physical cleaning, especially corona pretreatment, and plasma treatment. The textile may be pretreated in particular by flaming. Foils, especially aluminum foils, may be pretreated in particular with an antifog spray coating. In this way, particularly effective adhesion between the substrate and the component is achieved.

A further aspect of the invention relates to a system, in the sense of a kit of parts. The system comprises (i) at least one cyanate ester including at least two OCN groups, (ii) at least two different catalysts for the trimerization reaction of OCN groups to form a triazine ring, which are retained reversibly on a carrier, particularly a pyrogenic silica and also (iii) optionally instructions for use for a method for coating a component as elucidated above.

Polyfunctional Cyanate Esters

Preferred cyanate esters including at least two OCN groups are based on novolacs, known, for example, under the tradenames Huntsman Cyanatester AroCy XY371 or Primaset™ cyanate esters from Lonza.

Novolacs are polycondensation products of formaldehyde and phenols that are prepared with acid catalysis and belong to the group of the phenolic resins (cf. Chemie Lexikon, Römpp (ed.), 9^{th} edn. 1991, vol. 4, entry heading “Novolake”).

Metallic Catalysts

These are compounds which include a metal atom together with organic radicals. Examples are metals, such as tin, titanium, zinc, lead, bismuth, iron, cobalt, nickel, calcium, barium, manganese, vanadium, zirconium, and/or aluminum. They may be present in the form, for example, of a carboxylic acid salt, chelate, such as acetylacetonate, for example, hydroxide, alkoxide, phenoxide, or oxide; mixed groups in the metal catalyst are also known. These compounds more particularly are compounds of Sn, Fe, Ti, Al, Bi or Zr as carboxylic acid salt, oxide, hydroxide or acetylacetonate. One preferred metallic catalyst is tin octoate. Tin octoate is also known as tin ethylhexanoate or tin(II) 2-ethylhexanoate. The amount may be 0.001 to 10 wt %, based on the overall composition. Preferred amounts are 0.01 to 5 wt %, particularly 0.1 to 1 wt %.

Nonmetallic Catalysts

Preferred nonmetallic catalysts are substituted ureas, particularly diphenylurea (from Sigma Aldrich), imidazoles, particularly dimethylimidazole or 2,4-diamino-6-[2′-methylimidazol-1′-yl]ethyl-s-triazines (Curezol 2 MZ azines from Air Products), or tetraalkylammonium carboxylates, particularly tetraethylammonium benzoates.

Carrier Substances

Carrier substances are preferably pyrogenic silica, as for example Aerosil 200 from Evonik, or pyrogenic metal oxides, examples being Aeroxides or aluminum oxides. Porous carriers may be zeolites and also precipitated silicas, e.g., Sipernat from Evonik.

The carriers preferably have a BET surface area in the range from 5 to 400 g/m2, more preferably in the range from 10 to 200 g/m2.

### EXAMPLES

Below, aspects of the cyanate ester-based adhesive of the invention and, respectively, of the method for producing the cyanate ester-based adhesive are elucidated in more detail with reference to working examples.

The materials used are listed below:

| Tradename | Material | Manufacturer |
|---|---|---|
| Primaset PT-30 | Novolac-based cyanate | Lonza |
| | ester, 100% solids content | |
| Aerosil 200 | Pyrogenic silica | Evonik |
| WorleeAdd | Liquid tin octoate on | Worleé-Chemie |
| ST-70 | an amorphous silicate | |
| | powder as carrier substance | |

### Comparative Example

The comparative example concerns the incorporation of tin octoate without an adsorption step on a pyrogenic silica in a cyanate ester-based adhesive. For this example, 245 g of novolac-based cyanate ester with 100% solids content (Primaset PT-30, Lonza) were preheated at 60° C., 0.245 g of tin octoate (Borchi Kat 28) and 9.8 g of pyrogenic silica (Aerosil 200, Evonik) were added, and mixing took place with a laboratory mixer at 750 rpm (revolutions per minute). The mixture was stored at 60° C.

### Working Example

The working example concerns the incorporation of tin octoate, which is retained reversibly on a pyrogenic silica (WorleeAdd ST-70), into a cyanate ester-based adhesive. For this purpose, first 245 g of Primaset PT-30 are preheated in an oven at 60° C. Then 0.355 g of tin octoate, which is retained reversibly on a pyrogenic silica (Worlee-Add ST-70), and 9.7 g of pyrogenic silica (Aerosil 200, Evonik) were added and the mixture was dispersed in a laboratory mixer at 750 rpm. The mixture was stored at 60° C.

DSC Measurements (Netzsch DSC 204 F1 Phoenix with Autosampler and Intracooler ETK100/A)

| | Area | Reaction | Reaction |
|---|---|---|---|
| | J/g | range [° C.] | peak [° C.] |
| Comparative example | 578 | 159 to 330 | 238/261 |
| Working example | 600 | 170 to 329 | 264 |

The DSC measurements were carried out in a cold-welded, 25 μl aluminum crucible with aluminum lid. 9 to 11 mg of an adhesive sample corresponding to the comparative and working examples were weighed out. The measurement was carried out at 25° C. to 400° C. at 10° C./min with synthetic air flushing (40 ml/min), followed by an isothermal step at 400° C. for 5 h with synthetic air purging (40 ml/min).

Brookfield Viscosity Measurements (Brookfield RVDVI+)

| | [mPas] | | | | | | |
|---|---|---|---|---|---|---|---|
| | after | after | after | after | after | after | after |
| | prep. | 1 d | 2 d | 3 d | 4 d | 7 d | 8 d |
| Comparative | 10 300 | 12 750 | 16 700 | 21 300 | 23 900 | 31 300 | 32 750 |
| example | | | | | | | |
| Working | 12 250 | 16 100 | 17 800 | 16 450 | 17 100 | 21 900 | 21 350 |
| example | | | | | | | |

| | [mPas] | | | | |
|---|---|---|---|---|---|
| | after | after | after | after | after |
| | 9 d | 14 d | 15 d | 16 d | 17 d |
| Comparative | 36 250 | 49 750 | >100 000 | >100 000 | >100 000 |
| example | | | | | |
| Working | 20 900 | 28 000 | 31 750 | 32 550 | 32 550 |
| example | | | | | |

The adhesives of the comparative example and working example were stored before the viscosity measurement at 60° C. for a duration as indicated in the table above.

After 7 months of storage at room temperature (around 20 to 23° C.), the comparative example had a Brookfield viscosity of >100 000 mPas and the working example had a Brookfield viscosity of 23 800 mPas.

The Brookfield viscosity measurements were carried out according to method B of “ASTM D1084-97 (Reapproved 2005)” (Standard Test Methods for Viscosity of Adhesives). Measurement here took place with spindle #6 at 20 rpm and 60° C.

In comparison to the comparative example, the working example according to the invention exhibits significantly improved storage stability. Whereas the cyanate ester-based adhesive of the comparative example exhibits a significantly higher viscosity after just 3 days of storage, and after 15 days it is no longer possible to measure the viscosity, the cyanate ester-based adhesive of the working example has comparatively low viscosity figures over at least 17 days. Accordingly, the adhesive of the working example can be processed for much longer after production.

The cyanate ester-based adhesives thus produced can be applied using standard commercial hotmelt coating systems at 60 to 90° C. onto fabric (preferably glass) or aluminum foil. In this way the fabrics are coated with a noncrosslinked cyanate ester-based adhesive—in other words, there is no crosslinking during the coating of the fabrics. The typical application rates are between 30 and 70 g/m². Employed are a gravure roll (Cavitec, Lacom), engraved roller, positive, or screen (System Nordson, Cavitec, J. Zimmer).

1-14. (canceled)

15. A cyanate ester-based adhesive comprising:
component A, which includes at least one cyanate ester having at least two OCN groups, and
component B, which includes at least one catalyst for the trimerization reaction of OCN groups to form a triazine ring,
wherein the at least one catalyst is tin octoate and is retained reversibly on a carrier by physical or chemical adsorption.

16. The cyanate ester-based adhesive according to claim 15, wherein the at least one catalyst is in a non-complexed state.

17. The cyanate ester-based adhesive according to claim 15, wherein the carrier is a pyrogenic silica.

18. A method for producing a cyanate ester-based adhesive according to claim 15, comprising a step a) of:
contacting the component A, which includes at least one cyanate ester having at least two OCN groups, and the component B, which includes at least one catalyst comprising tin octoate, for the trimerization reaction of OCN groups to form a triazine ring, in a solution,
wherein the catalyst is retained reversibly on the carrier by physical or chemical adsorption.

19. The method according to claim 18, wherein the contacting in step a) takes place at a temperature of 20 to 100° C. for a time of 1 to 10 min.

20. The method according to claim 18, wherein at least one of the component A and the component B is provided as solution in step a).

21. The method according to claim 18, wherein the components A and B are both provided as solids in step a).

22. A method for coating a component with a cyanate ester-based adhesive according to claim 15, comprising the steps of:
a) applying a cyanate ester-based adhesive to a substrate,
b) applying the component to the cyanate ester-based adhesive applied to the substrate, and
c) crosslinking the cyanate ester-based adhesive at a temperature of >100° C.

23. The method according to claim 22, wherein the crosslinking takes place with exclusion of atmospheric moisture.

24. The method according to claim 22, wherein at least one of the substrate and the component are pretreated.

25. The method according to claim 15, wherein the carrier is pyrogenic silica.

26. The method according to claim 18, wherein step a) is followed by step b) of degassing the composition from step a) under reduced pressure.

27. The method according to claim 24, wherein the at least one of the substrate and the component are pretreated by at least one of chemical and physical cleaning.

28. A system according to claim 25, additionally comprising
(iii) instructions for use.
